(19) United States
(12) Patent Application Publication
(10) Pub. No.: US 2021/0051163 A1
(43) Pub. Date: Feb. 18, 2021

(54) IDENTIFICATION AND CONTROL OF SUSPICIOUS CONNECTED IDENTITIES AND ACTIVITIES

(71) Applicant: CyberArk Software Ltd., Petach-Tikva (IL)

(72) Inventor: Arik KUBLANOV, Petach-Tikva (IL)

(73) Assignee: CyberArk Software Ltd., Petach-Tikva (IL)

(21) Appl. No.: 16/540,856

(22) Filed: Aug. 14, 2019

(51) Int. Cl. H04L 29/06; G06F 17/18

(52) U.S. Cl. CPC H04L 63/1416; H04L 63/0428; G06F 17/18; H04L 63/20

(57) ABSTRACT

Disclosed embodiments relate to detecting temporal deviations indicative of suspicious network identities or activities. Techniques include identifying data communications exchanged between two or more connected resources; accessing a temporal profile for the data communications, the temporal profile indicating a time for one or more of the data communications to be exchanged; deploying the temporal profile for analyzing future data communications exchanged between the two or more connected resources; identifying a first data communication; determining an elapsed time parameter of the first data communication; comparing the elapsed time parameter to the temporal profile; determining, based on the comparison, that the elapsed time parameter exceeds the temporal profile; and determining, based on the elapsed time parameter exceeding the temporal profile, an existence of a suspicious connected identity or activity in a communication path between the two or more connected resources.

### BACKGROUND

Computing resources can be susceptible to attacks from unauthorized or foreign hardware components installed by a malicious individual. For example, an attacker may connect a data-collecting device inline with an ethernet cable and thus, may be able to collect data or intercept communications between two or more networked resources. Such an inline device may be an inexpensive Raspberry Pi device configured for communications monitoring, interception, or reconnaissance. In another example, a malicious device may be directly installed in a computing device, e.g., a laptop, desktop, or smartphone. The device may then listen to communications within the machine (e.g., along a communications bus, or at an external communications port), and possibly alter or report them to external sources in a covert manner.

While certain approaches may allow for detecting malicious software installed on a computing device, or analyzing unusual network communications activity, these techniques may not detect hardware directly connected to a device. Thus, a malicious device can be installed and operate undetected in a network. Connected resources may be vulnerable to continuous vulnerabilities in which malicious attackers can monitor network resources and collect data.

Thus, there are technological needs for systems and methods for detecting the existence of malicious or unauthorized hardware in computer systems and networks.

### SUMMARY

The disclosed embodiments describe systems and methods for monitoring connected resources. For example, in an exemplary embodiment, there may be a system including a non-transitory computer readable medium including instructions that, when executed by at least one processor, cause the processor to perform operations for detecting temporal deviations indicative of suspicious connected identities or activities. The operations may comprise identifying data communications exchanged between two or more connected resources; accessing a temporal profile for the data communications, the temporal profile indicating a time for one or more of the data communications to be exchanged; deploying the temporal profile for analyzing future data communications exchanged between the two or more connected resources; identifying a first data communication; determining an elapsed time parameter of the first data communication; comparing the elapsed time parameter to the temporal profile; determining, based on the comparison, that the elapsed time parameter exceeds the temporal profile; and determining, based on the elapsed time parameter exceeding the temporal profile, an existence of a suspicious connected identity or activity in a communication path between the two or more connected resources.

According to a disclosed embodiment, the two or more connected resources are part of a single endpoint computing resource.

According to a disclosed embodiment, the time for one or more of the data communications to be exchanged is a time elapsed between being transmitted from one of the two or more connected resources and being received.

According to a disclosed embodiment, the time for one or more of the data communications to be exchanged is based on a transmission time and a reception time.

According to a disclosed embodiment, the non-transitory computer readable medium is incorporated in a network switch.

According to a disclosed embodiment, the operations further comprise generating an alert or trigger based on the determined existence of the suspicious connected identity or activity.

According to a disclosed embodiment, the operations further comprise determining not to proxy future data communications between the two or more connected resources based on the determined existence of the suspicious connected identity or activity.

According to a disclosed embodiment, the data communications are serial communications.

According to a disclosed embodiment, the operations further comprise: identifying a second data communication; determining an elapsed time parameter of the second data communication; comparing the elapsed time parameter to the temporal profile; determining, based on the comparison, that the elapsed time parameter does not exceed the temporal profile; and obtaining, from a credentials repository, a credential based on the elapsed time parameter not exceeding the temporal profile.

According to a disclosed embodiment, the operations further comprise asserting the obtained credential, on behalf of one of the two or more connected resources, to another of the two or more connected resources.

According to another disclosed embodiment, a method may be implemented for detecting temporal deviations indicative of suspicious network identities or activities. The method may comprise: identifying data communications exchanged between two or more connected resources; accessing a temporal profile for the data communications, the temporal profile indicating a time for one or more of the data communications to be exchanged; deploying the temporal profile for analyzing future data communications exchanged between the two or more connected resources; identifying a first data communication; determining an elapsed time parameter of the first data communication; comparing the elapsed time parameter to the temporal profile; determining, based on the comparison, that the elapsed time parameter exceeds the temporal profile; and determining, based on the elapsed time parameter exceeding the temporal profile, an existence of a suspicious connected identity or activity in a communication path between the two or more connected resources.

According to another disclosed embodiment, the temporal profile is developed by taking a plurality of snapshots of times for one or more of the data communications to be exchanged, and building a statistical model based on the snapshots.

According to another disclosed embodiment, the method further comprises encrypting the data communications.

According to another disclosed embodiment, the method is performed transparently to the two or more connected resources.

According to another disclosed embodiment, the time for one or more of the data communications to be exchanged is a time elapsed between being transmitted from one of the two or more connected resources and being received.

According to another disclosed embodiment, the time for one or more of the data communications to be exchanged is based on a transmission time and a reception time.

According to another disclosed embodiment, the method further comprises sensing for at least one of voltage or current, and determining a disconnection status of one of the two or more connected resources.

According to another disclosed embodiment, the method further comprises generating an alert based on the determined existence of the suspicious connected identity or activity.

According to another disclosed embodiment, the method further comprises: identifying a second data communication; determining an elapsed time parameter of the second data communication; comparing the elapsed time parameter to the temporal profile; determining, based on the comparison, that the elapsed time parameter does not exceed the temporal profile; and obtaining, from a credentials repository, a credential based on the elapsed time parameter not exceeding the temporal profile.

According to another disclosed embodiment, the method further comprises asserting the obtained credential, on behalf of one of the two or more connected resources, to another of the two or more connected resources.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system for detecting temporal deviations indicative of suspicious network identities or activities, in accordance with disclosed embodiments.

FIG. 2 is a diagram of an exemplary system for monitoring communications between resources, in accordance with disclosed embodiments.

FIG. 3 is a diagram of an exemplary system for monitoring communications between resources via a network switch, in accordance with disclosed embodiments.

FIG. 4 is a diagram of an exemplary system for monitoring communications between resources using a monitoring device, in accordance with disclosed embodiments.

FIG. 5 is a diagram of another exemplary system for monitoring communications between resources using a monitoring device, in accordance with disclosed embodiments.

FIG. 6 is a diagram of an exemplary system for monitoring communications between resources using a number of monitoring devices, in accordance with disclosed embodiments.

FIG. 7 is a diagram of another exemplary system for monitoring communications between resources using a number of monitoring devices, in accordance with disclosed embodiments.

FIG. 8 is a diagram of an exemplary system for monitoring communications between resources of a single endpoint computing resource, in accordance with disclosed embodiments.

FIG. 9 is a flowchart of a method for monitoring communications between resources, in accordance with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

Disclosed embodiments provide systems and methods for monitoring connected resources to detect temporal deviations indicative of suspicious network identities or activities. For example, a system may include a malicious or otherwise unauthorized man in the middle (MitM) component or device designed to eavesdrop, intercept, or exfiltrate network communications. In some situations, the MitM device may be installed inline between existing network devices (e.g., between a computer and a router, between a switch and a printer, etc.), while in other cases the MitM device may be a microchip or other device implanted within a computing device.

In some embodiments, a monitoring device may monitor a communication path between connected resources. The communication path may be, for example, a serial communication path, Ethernet cable, coaxial connection, fiber optic cable, etc. The monitoring device may be connected inline with the serial/Ethernet cables of the connected resources' environment. Alternatively, the monitoring device may be configured (e.g., as software) in a network switch connected to multiple devices, or may be integrated into a particular computing device.

In some embodiments, the monitoring device may store software configured to cause the device, and/or one or more sensors of the device, to monitor the communication pathway to which it is connected. For example, the monitoring device may collect data related to transmissions sent via the communication pathway. Collected data may include, for example, a time of receipt of the transmission at the monitoring device, metadata associated with the transmission (e.g., transmission size, transmission time, etc.), electrical data (e.g., voltage, current, and/or resistance of the communication pathway), or an identity of the resources (e.g., by IP address, MAC address, etc.) from which and to which the transmission is sent.

The monitoring device may transmit collected data to a server. The server may store the collected data and may build a temporal profile associated with communications between a first resource and a second resource via the communication pathway. The temporal profile may, for example, store time-of-flight data associated with an average amount of time taken to transmit a signal from the first resource to the second resource via the communication pathway. In some instances, the time-of-flight data is specific to particular network resources (e.g., based on IP or MAC address), specific to particular types of communications packets, or specific to particular communicating applications. In further embodiments, the temporal profile may include additional information, for example, one or more resource identifiers, an average voltage, an average resistance, and/or an average current. For example, the monitoring device may include one or more sensors configured to monitor the voltage, current, and resistance of an ethernet cable connecting the resources.

In some embodiments, the system may detect whether an additional device has been connected in the communication pathway between the two resources. For example, a malicious (e.g., MitM) device may add distance to the path a transmission must travel between the first and second resources, thereby increasing the time it takes a transmission from the first resource to the second resource, or vice versa, to be completed. In some embodiments, a malicious device may affect the current, resistance, and/or voltage of the communication pathway. Further, a MitM device may cause time delays in the form of processing delays (e.g., if it functions to intercept, analyze, and route the communications it receives). By monitoring transmissions between resources, the monitoring device may gather and send transmission data to a monitoring server, thereby enabling the system to detect the presence of an unauthorized or unknown device. For example, an unauthorized device may be detected if an observed time-of-flight is greater than an expected average time of flight between the first and second resources. Similarly, if the voltage or current on the communications line is observed to change (e.g., drop due to the added line resistance of the unauthorized device), that may also signal a potentially malicious device being connected. Thus, the techniques described further below may identify anomalous transmissions, thereby identifying potential threats to the network or individual computing devices.

In some embodiments, the monitoring device may include one or more processors configured to execute software instructions for monitoring transmission times and other data between two or more connected devices. Such software may be passive or active. For example, in some embodiments, the monitoring device may send an alert to the server to stop communication between the resources if the determined transmission time falls outside the predetermined threshold. In other embodiments, the server may send an alert to a security team or security administrator monitoring the network to which the resources belong.

In some embodiments, the monitoring device may run software that can act as proxy for serial communications located on a supervisory control and data acquisition (SCADA) environment. Many protocols in such environments are not encrypted and may allow resources to communicate sensitive information in unencrypted formats, e.g., as text files. Thus, in some embodiments, a resource requesting access to another resource may not be granted valid credentials until the communication pathway between the resources has been checked for the presence of unauthorized devices.

For example, a first resource, e.g., a network endpoint, may send a randomly generated password received from a security system to the authentication device. The authentication device may validate the resource based on its associated identity and on the time-of-flight of the transmission including the random password. If the authentication device verifies the resource identity and the time-of-flight of the transmission falls within the predetermined threshold, then the device may communicate with a security system to retrieve a valid password to authenticate the resources.

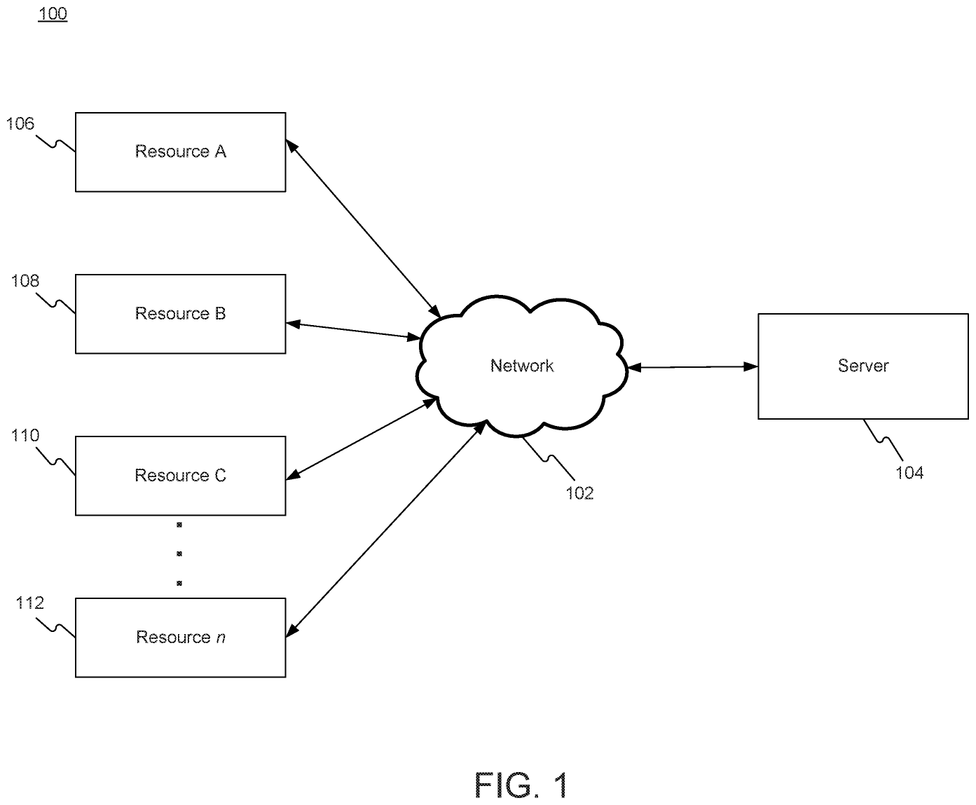

FIG. 1 is a block diagram of an exemplary system 100 for detecting temporal deviations indicative of suspicious network identities or activities, consistent with disclosed embodiments. System 100 may include a network 102, a server 104, and a number of resources 106-112 (Resource A, Resource B, Resource C, Resource n, respectively).

Server 104 and resources 106-112 may communicate via network 102. Network 102 may be, for example, all or a portion of a wired Local Area Network (LAN), a wireless WAN (e.g., WiMAX), a wireless LAN (e.g., IEEE 802.11, etc.), an enterprise or private data network, a storage area network, a virtual private network using a public network, a nearfield communications technique (e.g., Bluetooth™, infrared, etc.), or various other types of network communications. Server 104 and resources 106-112 may be connected to network 102 via wireless and/or wired connections. Communications via network 102 may be facilitated by one or more components, including, for example, a router, a modem, a repeater, a network switch, a proxy server, a network bridge, and the like. While system 100 is shown as a network-based environment, it is understood that the disclosed systems and methods may also be used in a localized system, with one or more of the components communicating directly with each other.

Server 104 may be one or more of various types of servers, whether a single server machine, a group of common server machines, or a server farm. As discussed further below, server 104 may be configured to perform various functions with resources 106-112, such as authentication of the resources 106-112 or users thereof, or identities associated with each of the resources 106-112. In various embodiments, server 104 may communicate with one or more other servers in network 102, or in other networks, to perform such authentication functionality. Server 104 may be, for example, a web server, an application server, an on-premises corporate server, a cloud-based server, etc. In some embodiments, resources 106-112 and server 104 may be part of the same network as network 102, a different network, or various private or on-premises networks.

Server 104 may be configured to monitor transmissions sent between networked resources. In some embodiments, server 104 may receive, via network 102, transmission data from the connected resources 106-112. Transmission data may include a timestamp, transmission identifier, origin (e.g., IP address of the originating resource), destination (e.g., IP address of the destination resource), etc. Server 104 may analyze the received data to identify completed transmissions and determine a time-of-flight associated with each completed transmission. Server 104 may aggregate time-of-flight information associated with transmissions between the same two resources to build a temporal profile associated with communications between the two resources. For example, a temporal profile associated with Resource A (106) and Resource B (108) may include an average time-of-flight of monitored transmissions from Resource A to Resource B and vice versa.

Resources 106-112 may include one or more resources and/or access-restricted resources, such as a secure database, servers that allow a user to interact with a remote application, or a client machine. A resource 106-112 may be various types of devices, applications, databases, servers, or network endpoints. Resource 106-112 may also include any wired or wireless device connected to any network resource. For example, resources 106-112 may be a modem, router, printer, network telephone, web camera, external storage device, etc. In some embodiments, access to resources 106-112 may be controlled, at least in part, by server 104. It is to be understood that any number of resources may be connected to, or part of, network 102 and/or system 100. In some embodiments, resources 106-112 may be devices external to, but in communication with, system 100.

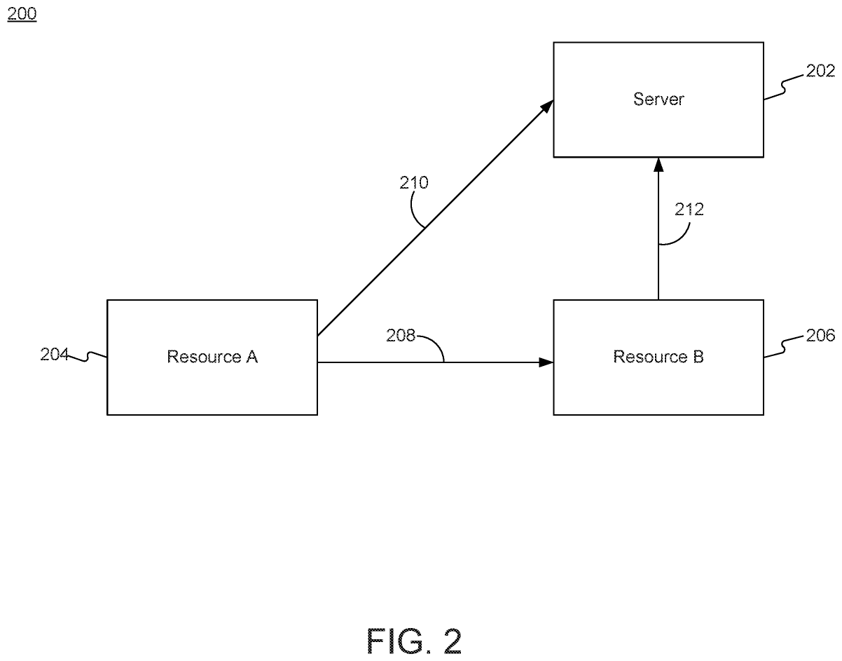

FIG. 2 is a diagram of an exemplary system 200 including a server 202, Resource A (204), and Resource B (206). In some embodiments, server 202 may execute the functions of a monitoring device based on transmission timing or electrical data received from the endpoints of the system, e.g., Resource A (204) and Resource B (206). As discussed with reference to FIG. 1, Resources A and B, 204 and 206, respectively, may be connected to server 202 via a direct connection or via network, e.g., network 102. In some embodiments, Resource A (204) may communicate with Resource B (206) through a wired or wireless connection. Server 202 may monitor communications between Resource A and Resource B to determine an average time-of-flight of transmissions between Resource A and Resource B. The average time may be, for example, the average time for a communication from Resource A to travel through the network (e.g., network 102) and/or one or more network components to reach Resource B, or the time to travel directly from Resource A to Resource B. Although server 202 is shown connected outside a direct connection 208 between Resource A and Resource B, in other embodiments server 202 is connected inline in connection 208.

Server 202 may monitor communications between Resource A and Resource B to build and store a temporal profile associated with Resources A and B. The temporal profile may include the average time-of-flight for transmissions between Resource A and Resource B. In some embodiments, the average time-of-flight is based on a minimum recorded number of transmissions. In some embodiments, a standard deviation of the average time-of-flight may be determined and stored. In other embodiments, server 202 may store a range of valid times based on the average time-of-flight. For example, the range may be the average plus-or-minus a number of standard deviations.

In some embodiments, one or more components or detectors associated with server 202 may monitor wired connections to collect voltage, resistance, and/or current measurements of the communication pathway between Resource A and Resource B. The temporal profile may further include an average voltage, average current, and/or average resistance through one or more components associated with a transmission between Resource A and Resource B. In a simplified example, where Resource A and Resource B are directly connected via an Ethernet cable, a sensor may record measurements of the voltage, current, and/or resistance through the Ethernet cable. An average voltage, average current, and/or average resistance may be based on a minimum number of random measurements, or on a minimum number of transmissions wherein a measurement by the sensor is triggered by each transmission.

In an exemplary interaction between Resource A and Resource B, at 208, Resource A may send a transmission to Resource B. The transmission may be, for example, a packet, a signal, a data stream, etc. Concurrently or in tandem, at 210, Resource A may also send a timestamp (e.g., potentially very precise, to the millisecond, microsecond, etc.) and other data associated with the transmission to server 202. When Resource B receives the transmission from Resource A, at step 212, Resource B may send a timestamp and other data associated with the receipt of the transmission to server 202. Server 202 may use the timestamp received from Resource A, associated with the transmission being sent, and the timestamp received from Resource B, associated with the transmission being received, to determine a time-of-flight of the transmission.

Server 202 may compare the determined time-of-flight with the stored temporal profile associated with Resources A and B. If the determined time-of-flight is not equal to the average time-of-flight, or is outside a predetermined threshold of the average time-of-flight, a malicious device may be connected at a point in the communication pathway between Resource A and Resource B.

In some embodiments, if the determined time-of-flight is outside the range associated with the temporal profile, server 202 may generate a message alerting IT personnel or a system administrator of a suspicious transmission between Resource A and Resource B. In other embodiments, in response to a suspicious transmission, server 202 may block communications to and from Resources A and B.

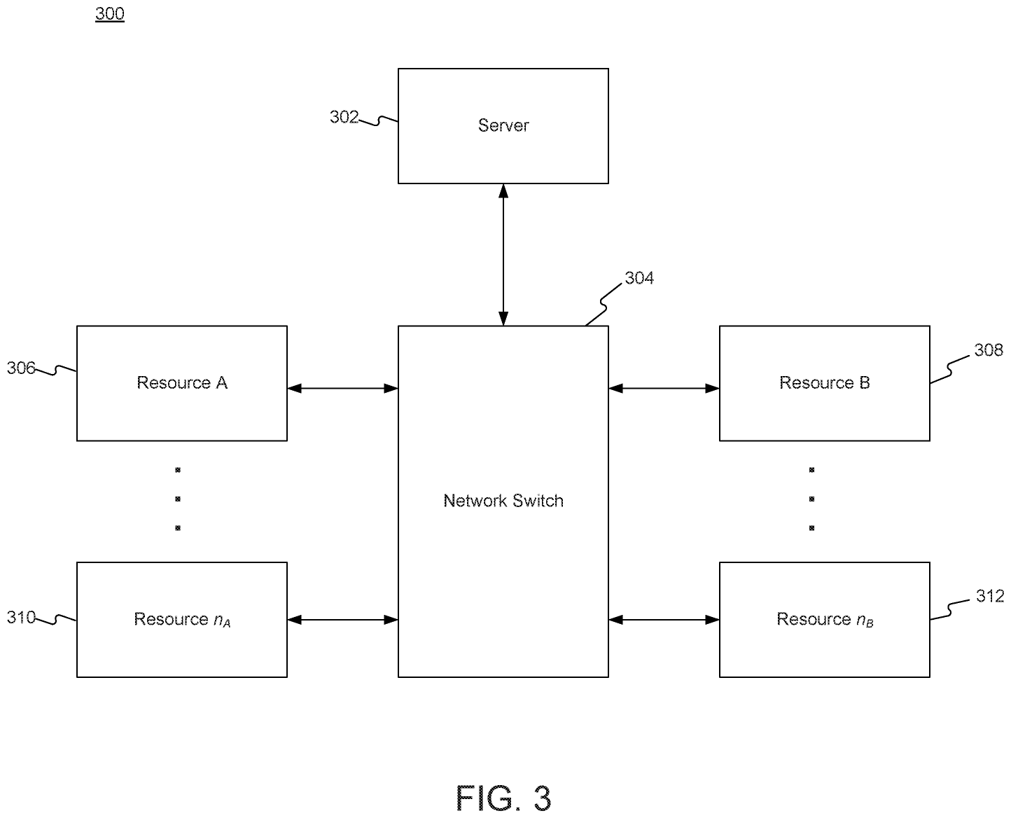

FIG. 3 is a diagram of another exemplary embodiment of a system 300 for detecting temporal deviations indicative of suspicious network identities or activities, consistent with disclosed embodiments.

System 300 may include a server 302, a network switch 304, and a number of resources 306-312. Network switch 304 may be a multi-port (e.g., 4-port, 24-port, 48-port, etc.) network switch configured to route packets between resources 306-312 and configured to function as a monitoring device to monitor transmissions between connected resources. Network switch 304 may store one or more computer programs configured to cause a processor to collect transmission data and send transmission data to server 302. Accordingly, network switch 304 may be originally fabricated by a manufacturer to include software for performing the monitoring techniques described below, or may be updated with such monitoring software after fabrication (e.g., as a software update, upgrade, or patch, etc.).

Network switch 304, for example, may be a server, network hub, repeater, network bridge, router, a layer-4 switch, or a layer-7 switch. Network switch 304 may be, for example, a device that receives messages from any resource connected to it and transmits the message to the resource or set of resources for which the message was intended (e.g., based on IP address, MAC address, or other network address data). In some embodiments, network switch 304 can send and receive messages to the devices connected to it at layers 1, 2, 3, 4, and/or 7 of the Open Systems Interconnection (OSI) model. Network switch 304 can also send and receive messages using any combination of the different layers. In various embodiments, network switch 304 may route electrical communications (e.g., via a Cat-5 ethernet cable, coaxial cable, etc.) or optical communications (e.g., via a fiber optic cable).

Server 302 may optionally be configured to receive transmission data collected by network switch 304. In some embodiments where network switch 304 itself is configured to perform the temporal monitoring and reporting functions described below, server 302 may or may not be implemented. In configurations involving server 302, server 302 may receive transmission data from any of the connected resources, e.g., resources 306-312 or from network switch 304. Server 302 may determine a time-of-flight of a transmission between Resource A and Resource B based on, for example: a departure time of a packet from Resource A, received by the server 302 or network switch 304 from Resource A; a receipt time of the packet at network switch 304 and a departure time of the packet from the network switch 304, received by the server 302 from the network switch 304; and a receipt time of the packet at Resource B, received by the server 302 from Resource B. Server 302 may use the time of departure from Resource A and the time of receipt by the network switch 304 to determine the duration of the first leg of the transmission. Server 302 may use the time of departure from network switch 304 and the time of receipt at Resource B to determine the second leg of the transmission. Thus, the total time-of-flight for the transmission is the combined duration of the first and second legs.

In other embodiments, network switch 304 may be configured to ping, i.e., send a signal (e.g., test packet, etc.), to one or all connected resources 306-312 at predetermined intervals of time or upon demand. In some embodiments, endpoints of the network may be pinged as part of a security audit to determine whether an unauthorized device is present in the system.

In some embodiments, network switch 304 may send a transmission identifier and timestamp associated with the ping to server 302. Server 302 may also receive, from the receiving resource, the transmission identifier and a timestamp associated with receipt of the transmission. In other embodiments, the ping may be configured to cause the receiving resource to return the ping. In this example, network switch 304 may transmit or record the time the transmission is sent, and the time the returned transmission is received. Server 302 or network switch 304 may use the received data to build a temporal profile of an average-time-of-flight for a transmission between network switch 304 and each of resources 306-312. In some embodiments, the time-of-flight is the time for the ping to travel from network switch 304 to the resource. In other embodiments, the time-of-flight is the time for the ping to travel from the network switch 304 to the resource and back to the network switch 304.

Thus, by building a temporal profile for each resource connected to network switch 304, system 300 may send periodic or on-demand pings to each resource to monitor the communication pathways of the network and to periodically check for the presence of an unauthorized device. Server 302 may receive, from network switch 304, a time-of-flight associated with a ping and compare that time-of-flight with the average time-of-flight stored in a temporal profile. Alternatively, such comparisons may be performed at network switch 304 itself.

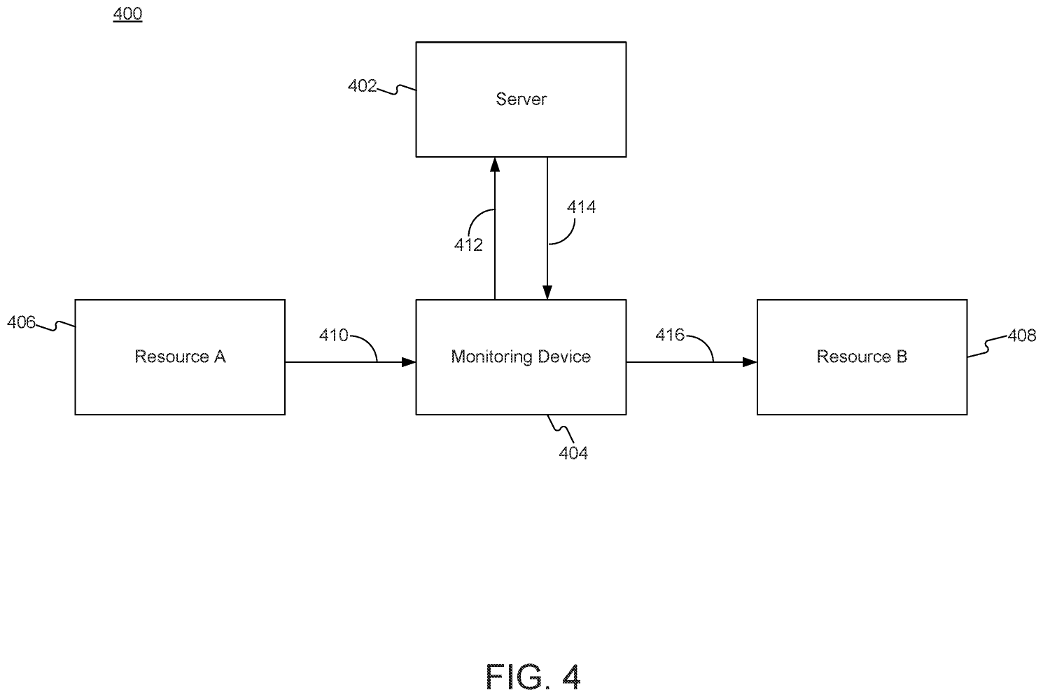

FIG. 4 is an exemplary system 400 for monitoring communications between resources, consistent with disclosed embodiments. System 400 may include a server 402, a monitoring device 404, a Resource A (406), and a Resource B (408). System 400 may be implemented to facilitate network communications between Resource A and Resource B.

At transmission 410, monitoring device 404 may receive a request or communication from Resource A addressed to Resource B. Monitoring device 404 may receive the request or communication and, at 412, transmit the time the request was received to server 402. Server 402 may also receive the time the request was sent from Resource A. Thus, the server 402 may use the request information to determine the time-of-flight of the request from Resource A to monitoring device 404.

Server 402 may compare the determined time-of-flight with a profile associated with the communication pathway between Resource A and the monitoring device 404. Alternatively, monitoring device 404 itself may receive the temporal information and develop the temporal profile itself. Accordingly, the comparison may in some embodiments be performed by monitoring device 404. In some embodiments, server 402 or monitoring device 404 may determine Resource A is authenticated based on the determined time-of-flight falling within a predetermined range based on an average time-of-flight for transmissions between Resource A and monitoring device 404.

If the time-of-flight is valid, per the temporal profile, at 414, server 402 may communicate with monitoring device 404 to allow communication from Resource A to Resource B. Monitoring device 404 may then, at 416, send the request from Resource A to Resource B, thereby allowing the resources to communicate using the pathway monitored by the monitoring device 404.

In some embodiments, at 416, server 402 may communicate additional instructions to monitoring device 404. For example, server 402 may initiate monitoring device 404 to send a ping to Resource B. Based on the determined time-of-flight of the ping from the monitoring device to Resource B, server 402 may also check for malicious devices connected to the communication pathway from the monitoring device 404 to Resource B. If the time-of-flight of the ping from the monitoring device 404 to Resource B falls within a predetermined range, based on the temporal profile associated with monitoring device 404 and Resource B, then server 402 may communicate with monitoring device 404 to cause the monitoring device 404 to allow the communication from Resource A to Resource B.

In some embodiments, if either the time-of-flight of the request from Resource A to the monitoring device 404 or the time-of-flight of the request from the monitoring device 404 to Resource B falls outside the predetermined range associated with either temporal profile, respectively, server 402 may communicate with monitoring device 404 to cause monitoring device 404 to cease communication with Resource A and Resource B. In some embodiments, server 402 may send instructions to monitoring device 404 to only cease communication to the resource associated with the invalid time-of-flight. In other embodiments, for example, if monitoring device 404 is part of a network switch, e.g., network switch 304, server 402 may instruct monitoring device 404 not to route any communication to the resource associated with the invalid time-of-flight.

In other embodiments, if a time-of-flight falls outside the predetermined range of the temporal profile, server 402 may initiate monitoring device 404 to send a series of probative pings to the resource. Server 402 may compare an average time-of-flight of the pings to the temporal profile to determine the likelihood of an unauthorized device being connected in the communication pathway to the resource.

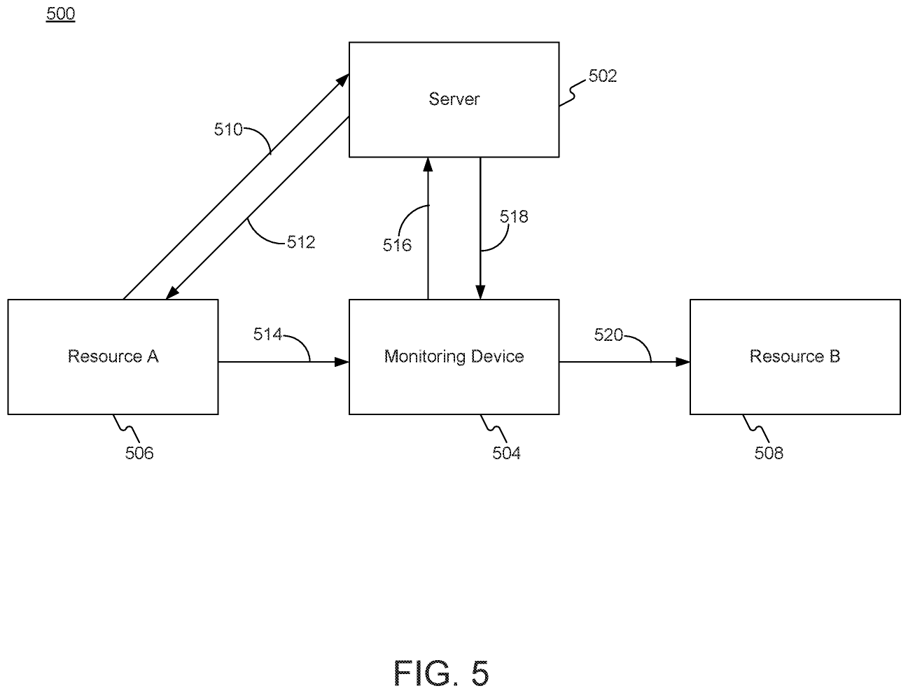

FIG. 5 is another exemplary system 500 for monitoring communications between resources, consistent with disclosed embodiments. System 500 may include a server 502, a monitoring device 504, a Resource A (506), and a Resource B (508). System 500 may be implemented to facilitate network communications between Resource A and Resource B, for example, when Resource A and Resource B communicate via a pathway employing a communication protocol that is not encrypted.

At 510, Resource A may request, from server 502, credentials to access Resource B. In some embodiments, server 502 may be associated with a credential storage system or credential vault (e.g., CyberArk™ vault). In response to the request, at 512, server 502 may transmit randomly generated or unique credentials to Resource A. Thus, Resource A is not provided with valid credentials to access Resource B until the pathway between Resource A and Resource B is checked for unauthorized devices, as described below.

At 514, Resource A transmits a request to access Resource B, including the random credentials, to Resource B. The request may be intercepted by monitoring device 504, which is connected inline in the communication pathway between Resource A and Resource B. At transmission 516, monitoring device 504 may transmit the time of receipt of the request to server 502. Server 502 may validate the time-of-flight of the request from Resource A to monitoring device 504 based on a temporal profile associated with the pathway between Resource A and monitoring device 504. In some embodiments, monitoring device 504 may store the temporal profiles associated with pathways to and from monitoring device 504 and may make the determination of whether a time-of-flight is indicative of the presence of an unauthorized device.

At 516, if the time-of-flight is valid per the temporal profile associated with the pathway between Resource A and monitoring device 504, server 502 may generate or retrieve valid credentials for Resource A and transmit these credentials to monitoring device 504. At 518, monitoring device 504 may send the request from Resource A to access Resource B, including the valid credentials, to Resource B, thereby allowing Resource A to communicate with Resource B over the validated pathway. As previously described with reference to FIG. 4, in some embodiments, server 502 may cause monitoring device 504 to send a probative ping (e.g., test packet) to Resource B prior to transmitting the request from Resource A to Resource B.

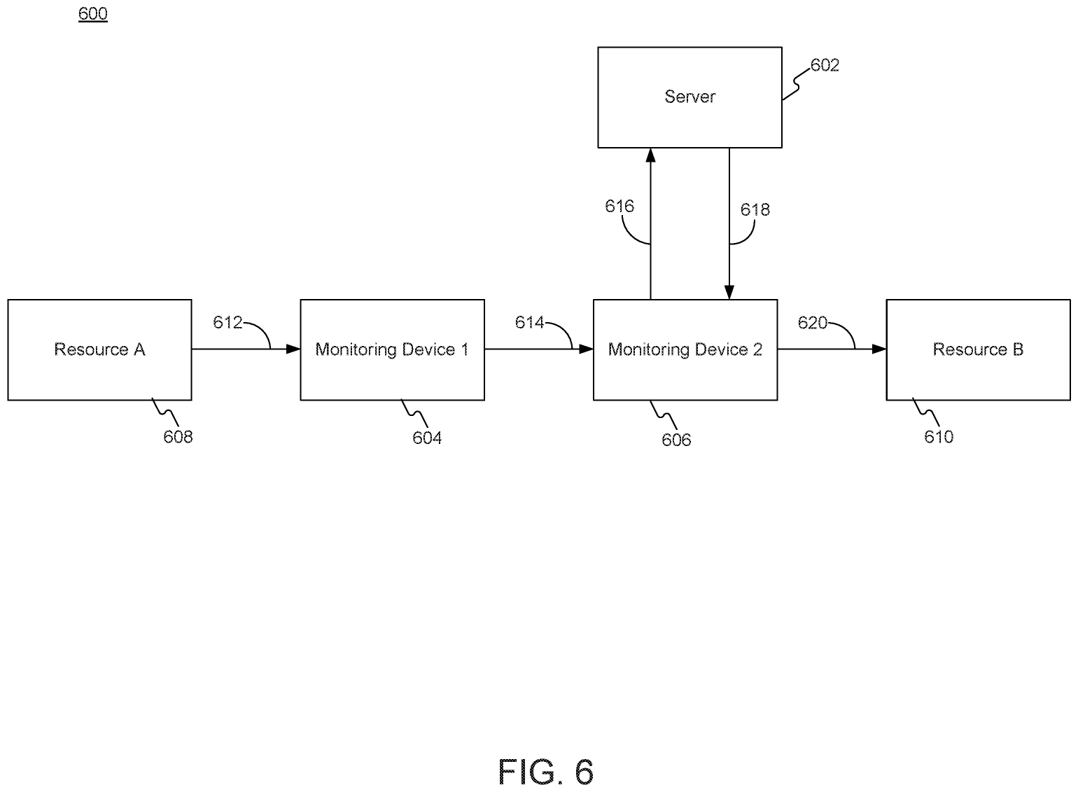

FIG. 6 is another exemplary system 600 for monitoring communications between resources, consistent with disclosed embodiments. System 600 may include a server 602, monitoring Device 1 (604), monitoring Device 2 (606), Resource A (608), and Resource B (610). System 600 may be implemented to facilitate communications between Resource A and Resource B. For example, system 600 may monitor communications between resources in environments using protocols that are not encrypted and therefore, passwords and credentials may be transmitted between resources in an unencrypted format, leaving them vulnerable to interception by a malicious device (e.g., connected inline at 612, 614, or 620).

At 612, monitoring Device 1 may receive a request from Resource A to communicate with Resource B. The request may include randomly generated credentials for accessing Resource B. For example, Resource A may receive randomly generated credentials from a credential vault (e.g., CyberArk™ vault) or from one or more security protocols operating on resource A. At 614, monitoring Device 1 may encrypt the request and received random credentials, and transmit the encrypted request to monitoring Device 2. In some embodiments, monitoring Device 1 may include in the transmission to monitoring Device 2 the time the request was received at monitoring Device 1 from Resource A.

At 618, monitoring Device 2 may transmit the time the request from Resource A was received at monitoring Device 1 and the time that the request was received at monitoring Device 2 from monitoring Device 1 to server 602. In some embodiments, Resource A may transmit the time the request was sent to Resource B to server 602. In some embodiments, server 602 may associate the received time information with the request based on, for example, origin and/or destination identifiers or transmission identifiers received as part of the request, e.g., in a packet header. In other embodiments, a monitoring device (e.g., device 604 or 606) may extract origin, destination, and identifier information from a packet header and transmit the extracted information to server 602.

Server 602 may associate the sent and received times of the requests with their respective communication pathways, e.g., from Resource A to monitoring Device 1 and from monitoring Device 1 to monitoring Device 2, to determine the time-of-flight of the request along each segment of the pathway between Resource A and Resource B. Alternatively, as discussed above, in some embodiments monitoring devices 604 and/or 606 may generate the temporal profiles and perform the observations of real-time time-of-flight data.

Server 602 may compare the determined time-of-flights with profiles associated with the communication pathways between Resource A and monitoring Device 1 and monitoring Device 1 and monitoring Device 2, respectively. In some embodiments, server 602 may determine Resource A is authenticated based on the determined total time-of-flight from Resource A to monitoring Device 2 falling within a predetermined range based on an average time-of-flight for transmissions between Resource A and monitoring Device 2. In other embodiments, server 602 may validate each segment of the pathway (e.g., Resource A to monitoring Device 1, and monitoring Device 1 to monitoring Device 2) based on separate temporal profiles associated with each segment.

If the time-of-flight(s) is valid, per the temporal profile(s), at 618, server 502 may communicate with monitoring Device 2 to allow communication from Resource A to Resource B. Monitoring Device 2 may then, at 620, send the request from Resource A to Resource B, thereby allowing the resources to communicate using the pathway monitored by the monitoring Device 2. In some embodiments, server 602 may transmit valid credentials for Resource A to access Resource B to monitoring Device 2 to be included with the request sent from monitoring Device 2 to Resource B.

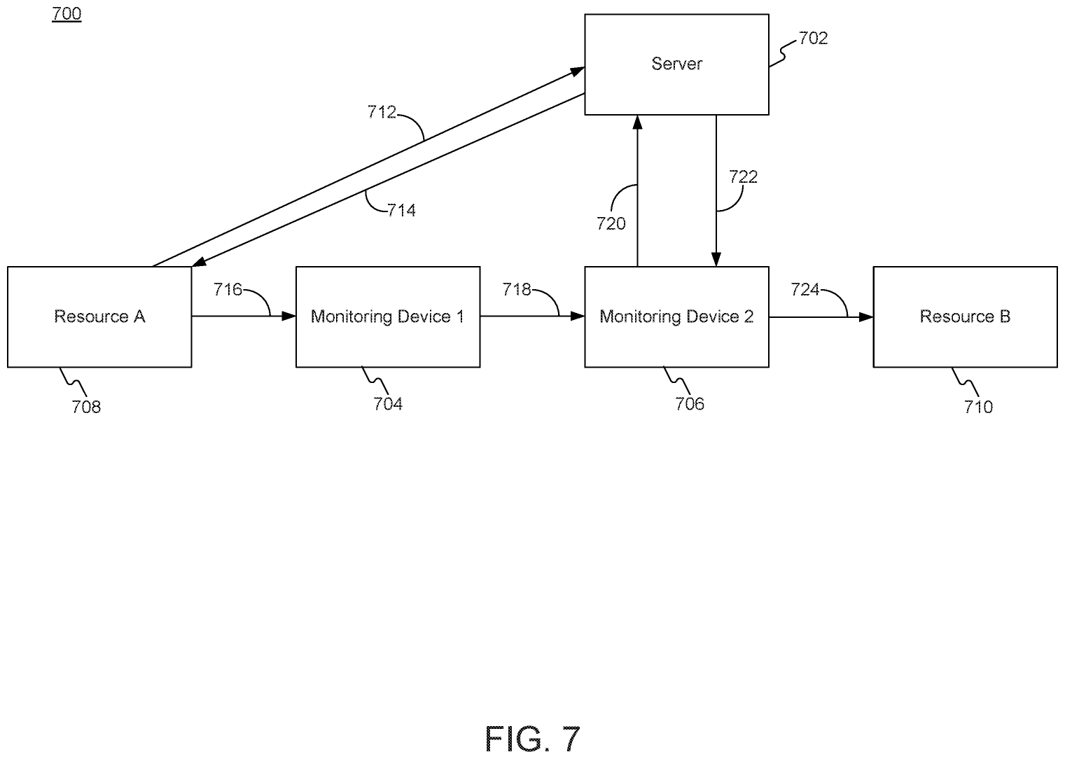

FIG. 7 is another exemplary system 700 for monitoring communications between resources, consistent with disclosed embodiments. System 700 may include a server 702, monitoring Device 1 (704), monitoring Device 2 (706), Resource A (708), and Resource B (710). System 700 may be implemented to facilitate communications between Resource A and Resource B. In some embodiments, monitoring Device 1 and monitoring Device 2 may be part of the same hardware component connected inline between Resource A and Resource B. In other embodiments, monitoring Device 1 and monitoring Device 2 may be separate devices or may be part of separate hardware components connected inline to different segments of the pathway between Resource A and Resource B.

At transmission 712, Resource A may request, from server 702, credentials to access Resource B. In some embodiments, server 702 may be associated with a credential storage system or credential vault. In response to the request, at 714, server 702 may transmit randomly generated credentials to Resource A. Thus, Resource A is not provided with valid credentials to access Resource B until the pathway between Resource A and Resource B is checked for unauthorized devices, as described below.

At transmission 716, Resource A transmits a request to access Resource B, including the random credentials, to Resource B. The request may be intercepted by monitoring Device 1, which is connected inline in the communication pathway between Resource A and Resource B. Monitoring Device 1 may encrypt the request and random credentials and, at 718, monitoring Device 1 may encrypt the request and received random credentials and transmit the encrypted request to monitoring Device 2. In some embodiments, monitoring Device 1 may include the time the request was received at monitoring device 1 from Resource A in the transmission to monitoring Device 2.

At 720, monitoring Device 2 may transmit the time of receipt of the request to server 702. Server 702 may associate the sent and received times of the requests, received from monitoring Device 2, Resource A, and/or monitoring Device 1, with their respective communication pathways, e.g., from Resource A to monitoring Device 1 and from monitoring Device 1 to monitoring Device 2, to determine the time-of-flight of the request along each segment of the pathway between Resource A and Resource B.

Server 702 may compare the determined time-of-flights with profiles associated with the communication pathways between Resource A and monitoring Device 1 and monitoring Device 1 and monitoring Device 2, respectively. Alternatively, monitoring devices 704 and/or 706 may develop the temporal profiles and perform the comparisons. In some embodiments, server 702 may determine Resource A is authenticated based on the determined total time-of-flight from Resource A to monitoring Device 2 falling within a predetermined range based on an average time-of-flight for transmissions between Resource A and monitoring Device 2. In other embodiments, server 602 may validate each segment of the pathway (e.g., Resource A to monitoring Device 1, and monitoring Device 1 to monitoring Device 2) based on separate temporal profiles associated with each segment.

At 722, if the time-of-flight is valid per the temporal profile associated with the pathways between Resource A and monitoring Device 1 and monitoring Device 1 and monitoring Device 2, respectively, server 702 may generate or retrieve valid credentials for Resource A and transmit these credentials to monitoring Device 2. At 724, monitoring Device 2 may send the request from Resource A to access Resource B, including the valid credentials, to Resource B, thereby allowing Resource A to communicate with Resource B over the validated pathway. As previously described with reference to FIG. 4, in some embodiments, server 702 may cause monitoring Device 2 to send a probative ping to Resource B prior to transmitting the request from Resource A to Resource B.

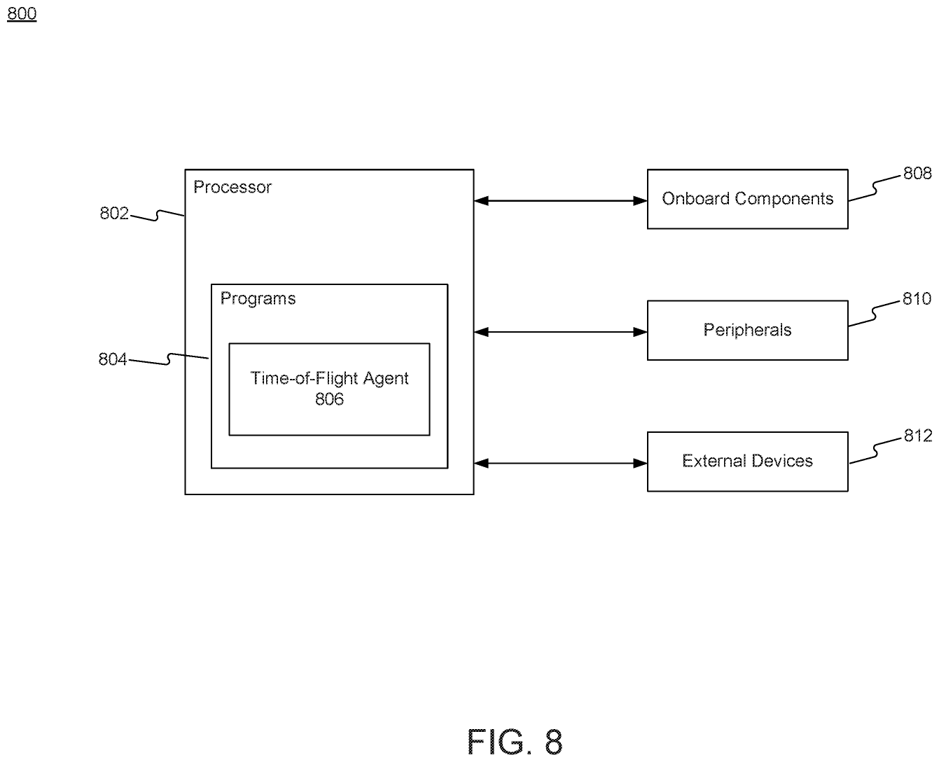

FIG. 8 is another exemplary embodiment of a system 800 for monitoring communications between resources. In the example of FIG. 8, the monitoring may be performed within a computing device, e.g., a laptop computer, a smartphone, a server, etc., consistent with disclosed embodiments. The techniques of FIG. 8 may be implemented via a circuit addition to a computer, or via a software update or upgrade.

In accordance with system 800, a computing device may include a processor 802 configured to execute one or more programs 804, e.g., including time-of-flight agent 806. Processor 802 may include one or more known processing devices, such as a microprocessor from the Pentium™ or Xeon™ family manufactured by Intel™, the Turion™ family manufactured by AMD™ or any of various processors manufactured by Sun Microsystems™ among others. One of ordinary skill in the art would understand that other types of processor arrangements could be implemented that provide for the capabilities disclosed herein. The disclosed embodiments are not limited to any type of processor(s) configured in computing system 800.

Processor 802 may be configured to perform functions related to the disclosed embodiments. For example, a memory of computing system 800 may be configured with software instructions, such as program(s) 804 that perform one or more operations when executed by processor 802. Programs 804 may include, for example, time-of-flight agent 806 configured to monitor system components.

Time-of-flight agent 806 may be configured to monitor communication pathways between components of a computing device. For example, time-of-flight agent 806 may monitor communications from the processor 802 to onboard components 808, peripheral components 810, and external devices 812. Onboard components 808 may include, for example, memory, network bus, one or more bridges, etc. Peripheral components 810 may include, for example, a graphics card, video card, audio card, disk drive, hard disk, power supply, etc. External devices 812 may include external components (e.g., keyboard, mouse, etc.) connected to the computing device, for example, via USB port, serial port, or other input.

Time-of-flight agent 806 may be configured to operate in a similar manner as monitoring device 404. For example, time-of-flight agent 806 may log communications between the central processing unit (CPU) and a keyboard connected via USB port. When input is received via the USB port and is communicated to the CPU, time-of-flight agent may compare the time it took the input to travel to the CPU with a temporal profile associated with the pathway from the keyboard and/or USB port to the CPU. If the time-of-flight exceeds a predetermined threshold, a malicious device may be connected to the keyboard, or USB port. Thus, the system may alert a user of the computing device or an IT administrator that an unauthorized device, e.g., a keylogger, skimmer, LAN turtle, etc., is connected to the computing system.

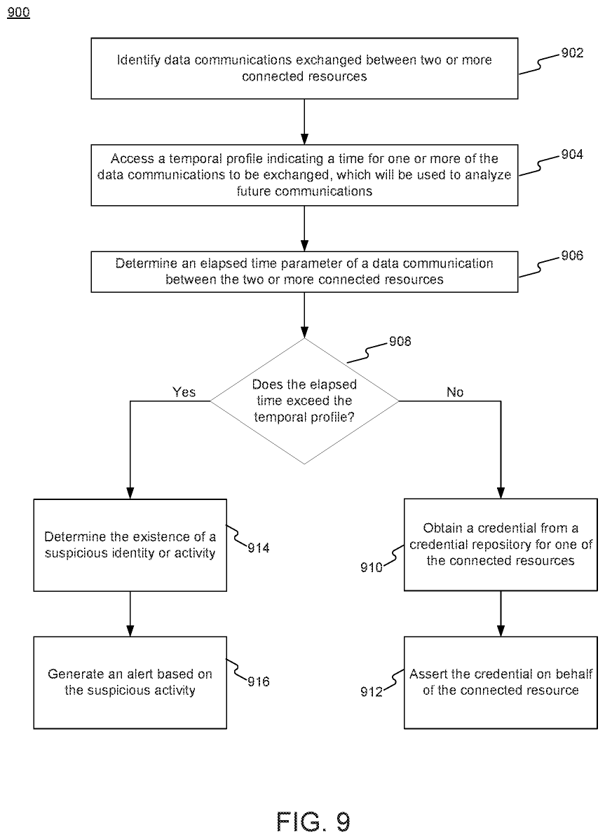

FIG. 9 is an exemplary method 900 for monitoring communications between connected resources. As described herein, connected resources may be one or more resources of a network or environment, or may be one or more resources within a single endpoint computing device, e.g., a personal computer, laptop, server, mobile device, etc.

At step 902, the system may identify data communications exchanged between two or more connected resources. For example, a server, switch, or monitoring device may identify data communications based on logs of outgoing and incoming transmissions sent and received from a connected resource. As discussed above, this may involve analyzing actual runtime communications between network devices, or may involve sending pings (e.g., test packets) to connected devices.

At step 904, the system may access a temporal profile for the data communications. As previously described, the temporal profile may indicate a time (e.g., average time, correct time, etc.) for one or more of the data communications to be exchanged. In some embodiments, the temporal profile may be based on a minimum number of transmissions or a minimum amount of time a communication path has been monitored. The system may deploy the temporal profile for analyzing future data communications exchanged between the two or more connected resources.

At step 906, the system may identify a data communication sent from a first resource to a second resource and may determine an elapsed time parameter of the data communication. In some embodiments, the elapsed time parameter for one or more of the data communications to be exchanged is a time elapsed between being transmitted from one of the two or more connected resources and being received. In some embodiments, the time for one or more of the data communications to be exchanged is based on a transmission time and a reception time. The system may receive the transmission and reception times from one or more transmission logs of the connected resources. Based on origin, destination, and identifier information, the system may match up information associated with a single transmission and use that information to determine the time elapsed, or time-of-flight.

At step 908, the system may compare the elapsed time parameter to the temporal profile associated with the connected resources. If the elapsed time parameter falls within a predetermined range associated with the temporal profile, at step 910, the system may obtain a credential from a credential repository for one of the connected resources, e.g., the requesting resource.

At step 912, the system may assert the credential on behalf of the connected resource. For example, as described above, a resource may transmit a request to access a secure resource using randomly generated or unique credentials. Once the communication pathway between the resource and the secure resource has been checked for unauthorized devices, the requesting resource, or a monitoring device of the system, may transmit the request from the requesting resource to the secure resource with the valid credentials.

If the elapsed time parameter exceeds the temporal profile, at step 914, the system may determine, based on the elapsed time parameter exceeding the temporal profile, an existence of a suspicious connected identity or activity in a communication path between the two or more connected resources. For example, if the time elapsed exceeds a predetermined average time allowed for transmissions between the resources, an unauthorized device may be present in the communication pathway between the two resources, thereby causing the time elapsed to increase. In other embodiments, an unauthorized device may also cause the current, voltage, and/or resistance associated with a communication pathway to change (e.g., current or voltage may drop, and resistance may increase). Thus, by detecting deviations from the average time elapsed, average voltage, average current, and/or average resistance, the system can determine the likelihood that an unauthorized device has been connected in the communication pathway in between two known devices.

At step 916, the system may generate an alert based on the suspicious activity. For example, the system may generate a message to a system administrator identifying the resources and the pathway associated with the requested communication. In some embodiments, the system may determine not to proxy future data communications between the two or more connected resources based on the determined existence of the suspicious connected identity or activity. In other embodiments, the system may generate and transmit one or more probative pings to the connected resource to verify that an unauthorized device may be connected.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials will be developed and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A non-transitory computer readable medium configured to monitor connected resources, including instructions that, when executed by at least one processor, cause the at least one processor to perform operations for detecting temporal deviations indicative of suspicious connected identities or activities, the operations comprising:
identifying data communications exchanged between two or more connected resources;
accessing a temporal profile for the data communications, the temporal profile indicating a time for one or more of the data communications to be exchanged;
deploying the temporal profile for analyzing future data communications exchanged between the two or more connected resources;
identifying, based on monitoring at a monitoring device, a first data communication;
determining an elapsed time parameter of the first data communication;
comparing the elapsed time parameter to the temporal profile;
determining, based on the comparison, that the elapsed time parameter exceeds the temporal profile;
determining, based on the elapsed time parameter exceeding the temporal profile, an existence of a suspicious connected identity or activity in a communication path between the two or more connected resources; and
transmitting instructions to the monitoring device to cause the monitoring device to
perform at least one of:
sending a ping to one of the two or more connected resources to determine whether a time-of-flight of the ping from the monitoring device to the one of the two or more connected resources falls within a predetermined range;
sending a series of pings to one of the two or more connected resources to facilitate a determination of a likelihood of an unauthorized device being connected in the communication path between the two or more connected resources;
ceasing communication with at least one of the two or more connected resources; or
transmitting or issuing an alert with respect to the existence of the suspicious connected identity or activity in the communication path between the two or more connected resources.

2. The non-transitory computer readable medium of claim 1, wherein the two or more connected resources are part of a single endpoint computing resource.

3. The non-transitory computer readable medium of claim 1, wherein the time for one or more of the data communications to be exchanged is a time elapsed between being transmitted from one of the two or more connected resources and being received.

4. The non-transitory computer readable medium of claim 1, wherein the time for one or more of the data communications to be exchanged is based on a transmission time and a reception time.

5. The non-transitory computer readable medium of claim 1, wherein the non-transitory computer readable medium is incorporated in a network switch.

6. The non-transitory computer readable medium of claim 1, wherein the operations further comprise generating an alert or trigger based on the determined existence of the suspicious connected identity or activity.

7. The non-transitory computer readable medium of claim 1, wherein the operations further comprise determining not to proxy future data communications between the two or more connected resources based on the determined existence of the suspicious connected identity or activity.

8. The non-transitory computer readable medium of claim 1, wherein the data communications are serial communications.

9. The non-transitory computer readable medium of claim 1, wherein the operations further comprise:
identifying a second data communication;
determining an elapsed time parameter of the second data communication;
comparing the elapsed time parameter to the temporal profile;
determining, based on the comparison, that the elapsed time parameter does not exceed the temporal profile; and
obtaining, from a credentials repository, a credential based on the elapsed time parameter not exceeding the temporal profile.

10. The non-transitory computer readable medium of claim 9, wherein the operations further comprise asserting the obtained credential, on behalf of one of the two or more connected resources, to another of the two or more connected resources.

11. A computer-implemented method for detecting temporal deviations indicative of suspicious network identities or activities, the method comprising:
identifying data communications exchanged between two or more connected resources;
accessing a temporal profile for the data communications, the temporal profile indicating a time for one or more of the data communications to be exchanged;
deploying the temporal profile for analyzing future data communications exchanged between the two or more connected resources;
identifying, based on monitoring by a monitoring device, a first data communication;
determining an elapsed time parameter of the first data communication;
comparing the elapsed time parameter to the temporal profile;
determining, based on the comparison, that the elapsed time parameter exceeds the temporal profile;
determining, based on the elapsed time parameter exceeding the temporal profile, an existence of a suspicious connected identity or activity in a communication path between the two or more connected resources; and
transmitting instructions to the monitoring device to cause the monitoring device to perform at least one of:
sending a ping to one of the two or more connected resources to determine whether a time-of-flight of the ping from the monitoring device to the one of the two or more connected resources falls within a predetermined range;
sending a series of pings to one of the two or more connected resources to facilitate a determination of a likelihood of an unauthorized device being connected in the communication path between the two or more connected resources;
ceasing communication with at least one of the two or more connected resources; or
transmitting or issuing an alert with respect to the existence of the suspicious connected identity or activity in the communication path between the two or more connected resources.

12. The computer-implemented method of claim 11, wherein the temporal profile is developed by taking a plurality of snapshots of times for one or more of the data communications to be exchanged, and building a statistical model based on the snapshots.

13. The computer-implemented method of claim 11, further comprising encrypting the data communications.

14. The computer-implemented method of claim 11, wherein the method is performed transparently to the two or more connected resources.

15. The computer-implemented method of claim 11, wherein the time for one or more of the data communications to be exchanged is a time elapsed between being transmitted from one of the two or more connected resources and being received.

16. The computer-implemented method of claim 11, wherein the time for one or more of the data communications to be exchanged is based on a transmission time and a reception time.

17. The computer-implemented method of claim 11, wherein the method further comprises sensing for at least one of voltage or current, and determining a disconnection status of one of the two or more connected resources.

18. The computer-implemented method of claim 11, further comprising generating an alert based on the determined existence of the suspicious connected identity or activity.

19. The computer-implemented method of claim 11, further comprising:
identifying a second data communication;
determining an elapsed time parameter of the second data communication;
comparing the elapsed time parameter to the temporal profile;
determining, based on the comparison, that the elapsed time parameter does not exceed the temporal profile; and
obtaining, from a credentials repository, a credential based on the elapsed time parameter not exceeding the temporal profile.

20. The computer-implemented method of claim 19, further comprising asserting the obtained credential, on behalf of one of the two or more connected resources, to another of the two or more connected resources.
